(19) United States
(12) Patent Application Publication
(10) Pub. No.: US 2024/0174851 A1
(43) Pub. Date: May 30, 2024

(54) POLYPROPYLENE COMPOSITE RESIN COMPOSITION AND MOLDED ARTICLE CONTAINING SAME

(71) Applicants: HYUNDAI MOTOR COMPANY, Seoul (KR); KIA CORPORATION, Seoul (KR); GS CALTEX CORPORATION, Seoul (KR)

(72) Inventors: Mun Gyu Bak, Hwaseong-si (KR); Ju Seong Park, Suwon-si (KR); Dae Sik Kim, Yongin-si (KR); Seok Jin Yong, Daejeon (KR); Hyung Tak Lee, Daejeon (KR); Ha Kyu Seo, Daejeon (KR)

(73) Assignees: HYUNDAI MOTOR COMPANY, Seoul (KR); KIA CORPORATION, Seoul (KR); GS CALTEX CORPORATION, Seoul (KR)

(21) Appl. No.: 18/231,622

(22) Filed: Aug. 8, 2023

(30) Foreign Application Priority Data
Nov. 22, 2022 (KR) 10-2022-0157536

(51) Int. Cl. C08L 53/00

(52) U.S. Cl. CPC C08L 53/00; C08L 2205/025; C08L 2205/035

(57) ABSTRACT

A polypropylene composite resin composition and a molded article made from same have improved impact resistance. The composition includes: a first propylene-ethylene block copolymer resin having a melt index of 20 to 40 g/10 min (230° C., 2.16 kg); a second propylene-ethylene block copolymer resin having a melt index of 5 to 15 g/10 min (230° C., 2.16 kg); a thermoplastic elastomer including at least one of a styrenic thermoplastic elastomer or an olefinic thermoplastic elastomer; an inorganic filler; and a nucleating agent in appropriate amounts.

### CROSS-REFERENCE TO RELATED APPLICATION

This application claims, under 35 U.S.C. § 119(a), the benefit of priority to Korean Patent Application No. 10-2022-0157536, filed on Nov. 22, 2022, the entire contents of which are incorporated herein by reference.

### BACKGROUND

### (a) Technical Field

The present disclosure relates to a polypropylene composite resin composition and a molded article containing the same.

### (b) Background Art

In general, polypropylene resin is widely used as a material for injection molded articles because it is lightweight and has superior mechanical properties relative to the price thereof. As a product becomes larger, efforts are made to decrease the wall thickness of the product in order to reduce the weight of the product.

However, the polypropylene resin is disadvantageous in that the thinner walled product may be easily broken by external impact, thus requiring not only high stiffness but also high impact resistance.

### SUMMARY

An object of the present disclosure is to provide a polypropylene composite resin composition having improved impact resistance while maintaining existing mechanical properties (high stiffness). Another object is to provide a molded article including the composition.

The objects of the present disclosure are not limited to the foregoing. The objects of the present disclosure should be more clearly understood through the following description and may be realized by the compositions and articles described in the claims and combinations thereof.

The present disclosure provides a polypropylene composite resin composition including: 40 to 60 percent by weight (wt %) of a first propylene-ethylene block copolymer resin having a melt index of 20 to 40 g/10 min (230 degrees Celsius (° C.), 2.16 kilograms (kg)); 5 to 15 wt % of a second propylene-ethylene block copolymer resin having a melt index of 5 to 15 g/10 min (230° C., 2.16 kg); 15 to 25 wt % of a thermoplastic elastomer including at least one of a styrenic thermoplastic elastomer, an olefinic thermoplastic elastomer, or a combination thereof; 15 to 25 wt % of an inorganic filler; and 0.2 to 2 wt % of a nucleating agent.

The first propylene-ethylene block copolymer resin may have a flexural modulus of 18,000 kilograms of force per square centimeter (kgf/cm²) or more.

The second propylene-ethylene block copolymer resin may have a flexural modulus of 17,000 kgf/cm² or more.

The second propylene-ethylene block copolymer resin may have Izod room-temperature impact strength (25° C.) of 10 kgf/cm² or more as measured according to Izod Impact Testing standard ISO 180.

The thermoplastic elastomer may include, based on the total weight of the composition: 5 to 10 wt % of a first olefinic thermoplastic elastomer having a melt index of 0.5 to 2 grams per 10 minutes (g/10 min) (230° C., 2.16 kg); 5 to 10 wt % of a second olefinic thermoplastic elastomer having a melt index of 20 to 40 g/10 min (230° C., 2.16 kg); and 5 to 10 wt % of a styrenic thermoplastic elastomer having a melt index of 10 to 20 g/10 min (230° C., 2.16 kg).

The inorganic filler may include at least one of talc, nanoclay, glass fiber, mica, calcium carbonate, wollastonite, barium sulfate, or any combination thereof.

The inorganic filler may have an average particle size of 2 micrometers (μm) or less.

The nucleating agent may include a sodium phosphate-based nucleating agent.

In addition, the present disclosure provides a molded article including the polypropylene composite resin composition described above.

The molded article may include a sun visor.

The molded article may have Izod room-temperature impact strength (23° C.) of 57 kgf/cm² or more and Izod low-temperature impact strength (−10° C.) of 32 kgf/cm² or more, as measured according to ISO 180.

### DETAILED DESCRIPTION

The above and other objects, features, and advantages of the present disclosure should be more clearly understood from the following embodiments. However, the present disclosure is not limited to the embodiments disclosed herein and may be modified into different forms. These embodiments are provided to thoroughly explain the disclosure and to sufficiently transfer the spirit of the present disclosure to those having ordinary skill in the art.

It should be further understood that the terms “comprise,” “include,” “have,” and the like, when used in this specification, specify the presence of stated features, integers, steps, operations, elements, components, or combinations thereof, but do not preclude the presence or addition of one or more other features, integers, steps, operations, elements, components, or combinations thereof.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

When a component, device, element, or the like, of the present disclosure, is described as having a purpose or performing an operation, function, or the like, the component, device, or element should be considered herein as being “configured to” meet that purpose or to perform that operation or function.

A polypropylene composite resin composition according to an aspect of the present disclosure includes: 40 to 60 percent by weight (wt %) of a first propylene-ethylene block copolymer resin having a melt index of 20 to 40 grams per 10 minutes (g/10 min) (230 degrees Centigrade (° C.), 2.16 kilograms (kg)); 5 to 15 wt % of a second propylene-ethylene block copolymer resin having a melt index of 5 to 15 g/10 min (230° C., 2.16 kg); 15 to 25 wt % of a thermoplastic elastomer including at least one of a styrenic thermoplastic elastomer, an olefinic thermoplastic elastomer, or a combination thereof; 15 to 25 wt % of an inorganic filler; and 0.2 to 2 wt % of a nucleating agent.

Before describing the present disclosure, the term “melt index” or MI refers to an index representing the melt flowability of a plastic material at a certain temperature under a certain load. A melt index within an appropriate range may be selected in consideration of all mechanical properties.

Individual components constituting the polypropylene composite resin composition according to the present disclosure are specified below.

### (A) First Propylene-Ethylene Block Copolymer Resin

The first propylene-ethylene block copolymer resin may be included in an amount of 40 to 60 wt % based on the total weight of the composition. If the amount of the first propylene-ethylene block copolymer resin is less than 40 wt %, impact strength may be deteriorated. On the other hand, if the amount of the first propylene-ethylene block copolymer resin exceeds 60 wt %, stiffness may be reduced, making it impossible to use as a material for automobile interiors.

The first propylene-ethylene block copolymer resin may be a highly crystalline polymer including a propylene homopolymer composed mainly of a propylene monomer and ethylene.

The first propylene-ethylene block copolymer resin may have a melt index (MI) of 20 to 40 g/10 min, as measured at 230° C. under a load of 2.16 kg. If the melt index of the first propylene-ethylene block copolymer resin is less than 10 g/10 min (230° C., 2.16 kg), processing may become difficult during injection due to lowered flowability. If the melt index of the first propylene-ethylene block copolymer resin exceeds 40 g/10 min (230° C., 2.16 kg), the balance between stiffness and impact resistance of the injection molded article may be lowered, which is undesirable.

The first propylene-ethylene block copolymer resin may have a flexural modulus of 18,000 kgf/cm² or more. Particularly, the first propylene-ethylene block copolymer resin may have a flexural modulus of 18,000-22,000 kgf/cm².

If the flexural modulus of the first propylene-ethylene block copolymer resin falls out of the above range, the performance of a final product may be deteriorated.

### (B) Second Propylene-Ethylene Block Copolymer Resin

The second propylene-ethylene block copolymer resin may be included in an amount of 5 to 15 wt % based on the total weight of the composition. If the amount of the second propylene-ethylene block copolymer resin is less than 5 wt %, impact strength may be deteriorated. On the other hand, if the amount of the second propylene-ethylene block copolymer resin exceeds 15 wt %, stiffness may be reduced, making it impossible to use as a material for automobile interiors.

The second propylene-ethylene block copolymer resin may be a highly crystalline polymer including a propylene homopolymer composed mainly of a propylene monomer and ethylene.

The second propylene-ethylene block copolymer resin may have a melt index (MI) of 5 to 15 g/10 min, as measured at 230° C. under a load of 2.16 kg. If the melt index of the second propylene-ethylene block copolymer resin is less than 5 g/10 min (230° C., 2.16 kg), processing may become difficult during injection due to lowered flowability. If the melt index of the second propylene-ethylene block copolymer resin exceeds 15 g/10 min (230° C., 2.16 kg), the balance between stiffness and impact resistance of the injection molded article may be lowered, which is undesirable.

The second propylene-ethylene block copolymer resin may have a flexural modulus of 17,000 kgf/cm² or more. Particularly, the second propylene-ethylene block copolymer resin may have a flexural modulus of 17,000-21,000 kgf/cm².

The second propylene-ethylene block copolymer resin may have Izod room-temperature impact strength (25° C.) of 10 kgf/cm² or more as measured according to Izod Impact Testing standard ISO 180. Particularly, the second propylene-ethylene block copolymer resin may have Izod room-temperature impact strength (25° C.) of 10 to 50 kgf/cm².

If the flexural modulus and impact strength of the second propylene-ethylene block copolymer resin fall out of the above ranges, the performance of the final product may be deteriorated.

### (C) Thermoplastic Elastomer

The thermoplastic elastomer may be included to attain impact resistance while maintaining the existing stiffness and strength properties of the polypropylene composite resin composition according to the present disclosure.

The thermoplastic elastomer may be included in an amount of 15 to 25 wt % based on the total weight of the composition. If the amount of the thermoplastic elastomer is less than 15 wt %, the impact resistance of the resin alone may be deteriorated, which is undesirable. On the other hand, if the amount of the thermoplastic elastomer exceeds 25 wt %, mechanical stiffness may be deteriorated.

The thermoplastic elastomer may include at least one of a styrenic thermoplastic elastomer, or an olefinic thermoplastic elastomer, or a combination thereof.

Like the styrenic thermoplastic elastomer, the olefinic thermoplastic elastomer serves as a rubber-based impact reinforcing material that supplements impact strength of the polypropylene resin.

The olefinic thermoplastic elastomer may be an ethylene-alpha-olefin copolymer. In the ethylene-alpha-olefin copolymer, the alpha-olefin may be an alpha-olefin having 4 or more carbon atoms. Particularly, an ethylene-butene-1 copolymer (EBM) or an ethylene-octene-1 copolymer (EOM) may be used as the copolymer of ethylene and alpha-olefin having 4 or more carbon atoms.

The olefinic thermoplastic elastomer may include a first olefinic thermoplastic elastomer and a second olefinic thermoplastic elastomer.

The first olefinic thermoplastic elastomer may have a melt index of 0.5 to 2 g/10 min (230° C., 2.16 kg). The first olefinic thermoplastic elastomer may be included in an amount of 5 to 10 wt % based on the total weight of the composition.

The second olefinic thermoplastic elastomer may have a melt index of 20 to 40 g/10 min (230° C., 2.16 kg). The second olefinic thermoplastic elastomer may be included in an amount of 5 to 10 wt % based on the total weight of the composition.

The styrenic thermoplastic elastomer serves as a rubber-based impact reinforcing material that supplements impact strength of the polypropylene resin. The styrenic thermoplastic elastomer may be included in an amount of 5 to 10 wt % based on the total weight of the composition. If the amount of the styrenic thermoplastic elastomer falls out of the above range, performance of a final product may be deteriorated.

The styrenic thermoplastic elastomer may be a styrene-diene copolymer. For example, the styrene-diene copolymer may be a copolymer, which may include at least one of a styrene-butylene-styrene block copolymer, a styrene-ethylene-butylene-styrene block copolymer, a styrene-isoprene-styrene block copolymer, a styrene-ethylene-propylene block copolymer, a styrene-ethylene-propylene-styrene block copolymer, or any combination thereof.

The styrenic thermoplastic elastomer may have a melt index of 10 to 20 g/10 min (230° C., 2.16 kg). The styrenic thermoplastic elastomer is capable of preventing dispersion from being deteriorated due to poor flowability by selecting a melt index of g/10 min or more, and of preventing impact resistance from being decreased by selecting a melt index of 20 g/10 min or less.

### (D) Inorganic Filler

The inorganic filler may be included to improve the dispersibility of the polypropylene composite resin composition according to the present disclosure.

The inorganic filler may be included in an amount of 15 to 25 wt % based on the total weight of the composition. If the amount of the inorganic filler is less than wt %, the effect of the inorganic filler on improving physical properties may be insignificant, which is undesirable. On the other hand, if the amount of the inorganic filler exceeds 25 wt %, stiffness may increase, but impact resistance may rapidly decrease, which is undesirable.

The inorganic filler may include at least one of talc, nanoclay, glass fiber, mica, calcium carbonate, wollastonite, barium sulfate, or any combination thereof. The inorganic filler that is used in the present disclosure may be talc.

The inorganic filler may have an average particle size of 2 micrometers (μm) or less.

Particularly, the inorganic filler may have a thickness of 0.1 to 2 μm.

If the average particle size of the inorganic filler is less than 0.1 μm, the particle size may be excessively small, and the addition effect thereof may become insignificant. On the other hand, if the average particle size of the inorganic filler exceeds 2 μm, stiffness, impact resistance, and mechanical performance may be deteriorated.

### (E) Nucleating Agent

The nucleating agent may be included to attain stiffness and dimensional stability by promoting crystallization of the polypropylene composite resin composition according to the present disclosure.

The nucleating agent may be included in an amount of 0.1 to 2 wt % based on the total weight of the composition. If the amount of the nucleating agent is less than 0.1 wt %, the effect thereof may be insignificant due to low addition thereof. Hence, stiffness and dimensional stability may be obtained only when the amount of the nucleating agent is 0.1 wt % or more. On the other hand, if the amount of the nucleating agent exceeds 2 wt %, the effect of improving physical properties may no longer be exhibited and the production cost may be increased, which is undesirable.

The nucleating agent that is used in the present disclosure may be a sodium phosphate-based nucleating agent.

Particularly, the sodium phosphate-based nucleating agent may be represented by Chemical Formula 1 below.

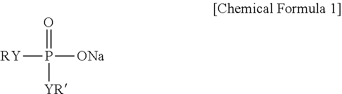

In Chemical Formula 1, R and R′ may be a hydrogen atom or a substituted or unsubstituted alkyl group, and R and R′ may be the same as or different from each other. The substituent (Y) may be a functional group such as a vinyl group, an amino group, a methacrylic group, an epoxy group, a mercapto group, a phenol group, or a phenyl group. Here, R and R′ may be bis(2,4-di-tert-butylphenol) or bis(4-tert-butylphenyl).

The sodium phosphate-based nucleating agent may be sodium methylene bis-(2,4-di-tert-butylphenol)phosphate or the like.

Another aspect of the present disclosure pertains to a molded article including the polypropylene composite resin composition. The molded article may have Izod room-temperature impact strength (23° C.) of 57 kgf/cm² or more and Izod low-temperature impact strength (−10° C.) of 32 kgf/cm² or more, as measured according to ISO 180. Particularly, the molded article may have Izod room-temperature impact strength (23° C.) of 57 to 70 kgf/cm² and Izod low-temperature impact strength (−10° C.) of 32 to 50 kgf/cm² as measured according to ISO 180.

The molded article according to the present disclosure may exhibit superior properties such as high stiffness and high impact resistance, and thus may be applied to home appliances, automobile exterior and interior parts, thin-film molded products, and the like.

In particular, the molded article according to the present disclosure is not limited in the field of use thereof but may be applied to a material for an automobile sun visor. When the polypropylene composite resin composition is applied to a material for an automobile sun visor, a skin layer, a lower pad, and an upper pad may be obviated by virtue of high stiffness and high impact resistance thereof. Accordingly, cost reduction and economic feasibility may be ensured through a simplified preparation process and weight reduction of materials for automobile sun visors.

A better understanding of the present disclosure may be obtained through the following examples. These examples are merely set forth to illustrate the present disclosure and are not to be construed as limiting the scope of the present disclosure.

A polypropylene composite resin composition was prepared through a typical method by mixing components in the amounts shown in Table 1 below.

### [Individual Components for Composition]

(A): Copolymer resin 1, a highly crystalline PP1, propylene-ethylene block copolymer resin, with MI of 20 to 30 g/10 min and flexural modulus of 18,000 kgf/cm² or more.

(B): Copolymer resin 1, a highly crystalline PP2, propylene-ethylene block copolymer resin, with MI of 5 to 15 g/10 min, flexural modulus of 17,000 kgf/cm² or more, and Izod room-temperature impact strength (25° C.) of 10 kgf/cm² or more.

(C): Elastomer 1, olefinic thermoplastic elastomer 1, with MI of 0.5 to 2 g/10 min.

(D): Elastomer 2, olefinic thermoplastic elastomer 2, with MI of 20 to 40 g/10 min.

(E): Elastomer 3, styrenic thermoplastic elastomer, with MI of 10 to 20 g/10 min.

(F): Inorganic filler 1, talc 1, with an average particle size of 2 μm or less.

(G): Inorganic filler 2, talc 2, with an average particle size of 10 μm.

(H): Nucleating agent, sodium phosphate-based nucleating agent.

TABLE 1

| | Component (wt %) | | | | | | | |
|---|---|---|---|---|---|---|---|---|
| Classification | (A) | (B) | (C) | (D) | (E) | (F) | (G) | (H) |
| Example 1 | 49 | 11 | 7 | 5 | 8 | 20 | — | 1 |
| Comparative Example 1 | 49 | 11 | 7 | 5 | 8 | — | 20 | — |
| Comparative Example 2 | 49 | 11 | 12 | 8 | — | 20 | — | — |
| Comparative Example 3 | 46 | 11 | 12 | 11 | — | 20 | — | — |

### Test Example

The properties of test specimens manufactured through a typical injection process using the polypropylene composite resin compositions according to an Example and Comparative Examples were measured as follows. The results thereof are shown in Table 2 below.

### Evaluation Methods

(1) Melt flow rate (MFR): Measurement was performed at 230° C. under a load of 3.8 kg according to ISO 1133.

(2) Tensile strength: Measurement was performed at 50 mm/min according to ISO 527.

(3) Flexural modulus, flexural strength: Measurement was performed at 2 mm/min according to ISO 178.

(4) IZOD impact strength: Measurement was performed at room temperature (23° C.) and low temperature (−10° C.) according to ISO 180.

(5) Heat deflection temperature (HDT): Measurement was performed under a load of 0.45 MegaPascals (MPa) at a heating rate of 120° C. according to ISO 75.

TABLE 2

| | Properties (ISO) | | | | | | |
|---|---|---|---|---|---|---|---|
| | | | (3) | (3) | | | |
| | | (2) Tensile | Flexural | Flexural | (4) Izod | (4) Izod | |
| | (1) MI | strength | strength | modulus | (23° C.) | (−10° C.) | (5) HDT |
| Classification | (g/10 min) | (Mpa) | (Mpa) | (Mpa) | (kJ/m²) | (kJ/m²) | (° C.) |
| Example 1 | 15.6 | 21 | 31.3 | 2040 | 57 | 32 | 114 |
| Comparative | 15.7 | 20.5 | 29.8 | 1920 | 54 | 29 | 107 |
| Example 1 | | | | | | | |
| Comparative | 16.2 | 21 | 31.7 | 2050 | 36.8 | 5.8 | 106 |
| Example 2 | | | | | | | |
| Comparative | 15.9 | 22 | 29.7 | 1870 | 39.5 | 6.4 | 100 |
| Example 3 | | | | | | | |

With reference to Table 2, in Comparative Example 1, in which the average particle size of the inorganic filler exceeded 2 μm, tensile strength, flexural strength, flexural modulus, Izod impact strength, and heat deflection temperature were low compared to Example 1 according to the present disclosure.

In Comparative Examples 2 and 3, which did not use a styrenic thermoplastic elastomer having a melt index of 10 to 20 g/10 min (230° C., 2.16 kg) and a sodium phosphate-based nucleating agent, Izod impact strength properties at room temperature and a low temperature were very low compared to Example 1 according to the present disclosure.

Moreover, in Comparative Example 3, in which the amount of each of the first olefinic thermoplastic elastomer having a melt index of 0.5 to 2 g/10 min (230° C., 2.16 kg) and the second olefinic thermoplastic elastomer having a melt index of 20 to 40 g/10 min (230° C., 2.16 kg) was greater than 10 wt %, flexural modulus and heat deflection temperature were low compared to Example 1 according to the present disclosure.

The tensile strength, flexural strength, flexural modulus, Izod impact strength, and heat deflection temperature of the specimens according to Comparative Examples 1-3 were imbalanced compared to Example 1, and this imbalance significantly deteriorated various characteristics of the final product.

In contrast, Example 1 included the first propylene-ethylene block copolymer resin having a melt index in a specific range, the second propylene-ethylene block copolymer resin having a melt index in a specific range, the styrenic thermoplastic elastomer, the first olefinic thermoplastic elastomer, the second olefinic thermoplastic elastomer, the inorganic filler, and the sodium phosphate-based nucleating agent were mixed in appropriate amounts. Example 1 exhibited improved impact resistance while maintaining existing mechanical properties (high stiffness).

Therefore, the polypropylene composite resin composition according to the present disclosure, in which individual components are used in appropriate amounts, is capable of exhibiting superior properties including both high stiffness and high impact resistance.

As is apparent from the above description, a polypropylene composite resin composition according to the present disclosure is capable of improving impact resistance while maintaining existing mechanical properties (high stiffness) by mixing a high-strength propylene-ethylene block copolymer resin, a thermoplastic elastomer in which a styrenic thermoplastic elastomer and an olefinic thermoplastic elastomer are mixed, an inorganic filler, and a nucleating agent in specific amounts.

In addition, a molded article according to the present disclosure can exhibit high stiffness and high impact resistance, and thus can be applied to home appliances, automobile exterior and interior parts, thin-film molded products, and the like.

The effects of the present disclosure are not limited to the above-mentioned effects. It should be understood that the effects of the present disclosure include all effects that can be inferred from the description of the present disclosure.

Although specific embodiments of the present disclosure have been described herein, those having ordinary skill in the art should appreciate that the present disclosure may be embodied in other specific forms without changing the technical spirit or essential features thereof. Thus, the embodiments described above should be understood to be non-limiting and illustrative in every way.

What is claimed is:

1. A polypropylene composite resin composition, comprising:
40 to 60 percent by weight (wt %) of a first propylene-ethylene block copolymer resin having a melt index of 20 to 40 grams per 10 minutes (g/10 min) (230 degrees Celsius (° C.), 2.16 kilograms (kg));
5 to 15 wt % of a second propylene-ethylene block copolymer resin having a melt index of 5 to 15 g/10 min (230° C., 2.16 kg);
15 to 25 wt % of a thermoplastic elastomer comprising at least one selected from among a styrenic thermoplastic elastomer and an olefinic thermoplastic elastomer;
15 to 25 wt % of an inorganic filler; and
0.2 to 2 wt % of a nucleating agent.

2. The polypropylene composite resin composition of claim 1, wherein the first propylene-ethylene block copolymer resin has a flexural modulus of 18,000 kilogram force per square centimeter (kgf/cm²) or more.

3. The polypropylene composite resin composition of claim 1, wherein the second propylene-ethylene block copolymer resin has a flexural modulus of 17,000 kgf/cm² or more.

4. The polypropylene composite resin composition of claim 1, wherein the second propylene-ethylene block copolymer resin has Izod room-temperature impact strength (25° C.) of 10 kgf/cm² or more as measured according to Izod Impact Testing standard ISO 180.

5. The polypropylene composite resin composition of claim 1, wherein the thermoplastic elastomer comprises, based on a total weight of the composition:
5 to 10 wt % of a first olefinic thermoplastic elastomer having a melt index of 0.5 to 2 g/10 min (230° C., 2.16 kg);
5 to 10 wt % of a second olefinic thermoplastic elastomer having a melt index of 20 to 40 g/10 min (230° C., 2.16 kg); and
5 to 10 wt % of a styrenic thermoplastic elastomer having a melt index of 10 to 20 g/10 min (230° C., 2.16 kg).

6. The polypropylene composite resin composition of claim 1, wherein the inorganic filler comprises at least one of talc, nanoclay, glass fiber, mica, calcium carbonate, wollastonite, barium sulfate, or any combination thereof.

7. The polypropylene composite resin composition of claim 1, wherein the inorganic filler has an average particle size of 2 micrometers (μm) or less.

8. The polypropylene composite resin composition of claim 1, wherein the nucleating agent comprises a sodium phosphate-based nucleating agent.

9. A molded article comprised of a polypropylene composite resin composition, the polypropylene composite resin composition comprising:
40 to 60 percent by weight (wt %) of a first propylene-ethylene block copolymer resin having a melt index of 20 to 40 grams per 10 minutes (g/10 min) (230 degrees Celsius (° C.), 2.16 kilograms (kg));
5 to 15 wt % of a second propylene-ethylene block copolymer resin having a melt index of 5 to 15 g/10 min (230° C., 2.16 kg);
15 to 25 wt % of a thermoplastic elastomer including at least one of a styrenic thermoplastic elastomer, an olefinic thermoplastic elastomer, or a combination thereof;
15 to 25 wt % of an inorganic filler; and
0.2 to 2 wt % of a nucleating agent.

10. The molded article of claim 9, wherein the molded article comprises a sun visor.

11. The molded article of claim 9, wherein the molded article has Izod room-temperature impact strength (23° C.) of 57 kilogram force per square centimeter (kgf/cm²) or more and Izod low-temperature impact strength (−10° C.) of 32 kgf/cm² or more, as measured according to Izod Impact Testing standard ISO 180.
